(19) United States
(12) Patent Application Publication
(10) Pub. No.: US 2005/0195370 A1
(43) Pub. Date: Sep. 8, 2005

(54) Transmissive/reflective light engine

(76) Inventors: Makarand P. Gore, Corvallis, OR (US); James Zhiqiang Guo, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/792,533

(22) Filed: Mar. 2, 2004

(51) Int. Cl. G03B 21/00

(52) U.S. Cl. 353/31

(57) ABSTRACT

A transmissive/reflective light engine comprising a plurality of light modulators, at least one light modulator transmitting certain wavelengths of the light to be projected towards a user and reflecting other wavelengths of the light. A light collector and reflector assembly that collects the reflected certain wavelengths of the light, and redirects at least some of the light reflected from the light modulator towards another one of the plurality of light modulators to be projected towards the user.

### BACKGROUND

The invention generally pertains to light engines for projectors or displays. A variety of light engine technologies selectively image by controlled delivery of light through an array of modulating devices. Light engines can be configured either as a light projector or as a light display. Light engines are formed with a planar array of light modulators, each of which can render a prescribed wavelength of light that can change at any given time. Each light modulator can be characterized as a transmissive device or a reflective device depending upon whether the modulator transmits or reflects light that is being delivered to the screen.

In conventional light engines hereto, any light that is not directed towards screen within any light engine represents largely wasted energy. Assuming that there are three color wavelengths of light that can be delivered from each modulator such as the red, green, and blue, only a third of the incident light is delivered to screen at any given time because only one primary color is displayed at any given time from each light modulator. As such, at least two-thirds of the light that is applied to the light engines is wasted, which corresponds to only a thirty-three percent efficiency for the light engine. The light engines are therefore not as efficient as desired. A relatively powerful light source is used to overcome the percent of wasted light. In general, more powerful light sources are more expensive and consume more power. It would therefore be desirable to increase the efficiency of light engines in such a manner that a less powerful, and less expensive, light source can be used to produce similar quality and brightness of image.

### BRIEF DESCRIPTION OF THE DRAWINGS

Illustrative and presently preferred embodiments of the invention are shown in the drawings, in which:

FIG. 1 is a block diagram of one embodiment of a transmissive /reflective light engine that is configured as a back-lit projection display.

FIG. 2 is a block diagram of one embodiment of a transmissive /reflective light engine that is configured as a front-lit projector.

FIG. 3 is a partial cross-sectional diagram of one embodiment of the transmissive/reflective light engine that includes a plurality of light sources.

FIG. 4 is a partial cross-sectional diagram of another embodiment of the transmissive/reflective light engine that includes at least one light source, external to the device.

FIG. 5 is a cross-sectional illustration of light being transmitted across, and reflected from, one display filter as shown in FIG. 3.

FIG. 6 is a block diagram of another embodiment of a transmissive/refractive light engine that is configured as a direct view display.

FIG. 7 is a front view of one embodiment of the transmissive /refractive light engine that is configured as a display as shown in FIG. 6 showing an image formed from a number of light modulators.

The same numbers are used throughout the document to reference like components and/or features.

### DETAILED DESCRIPTION

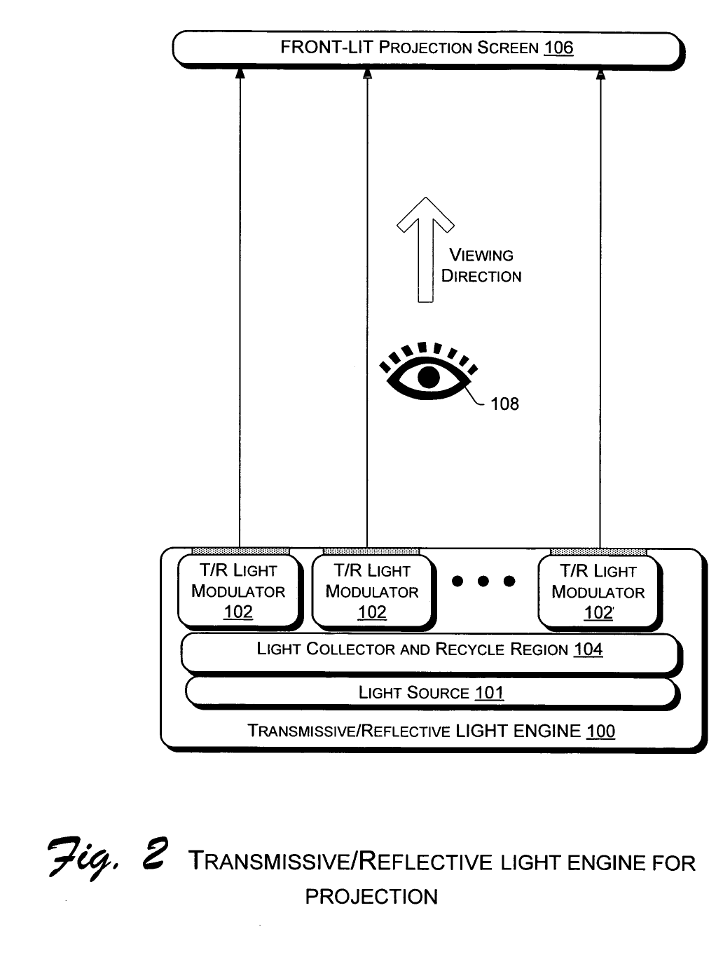

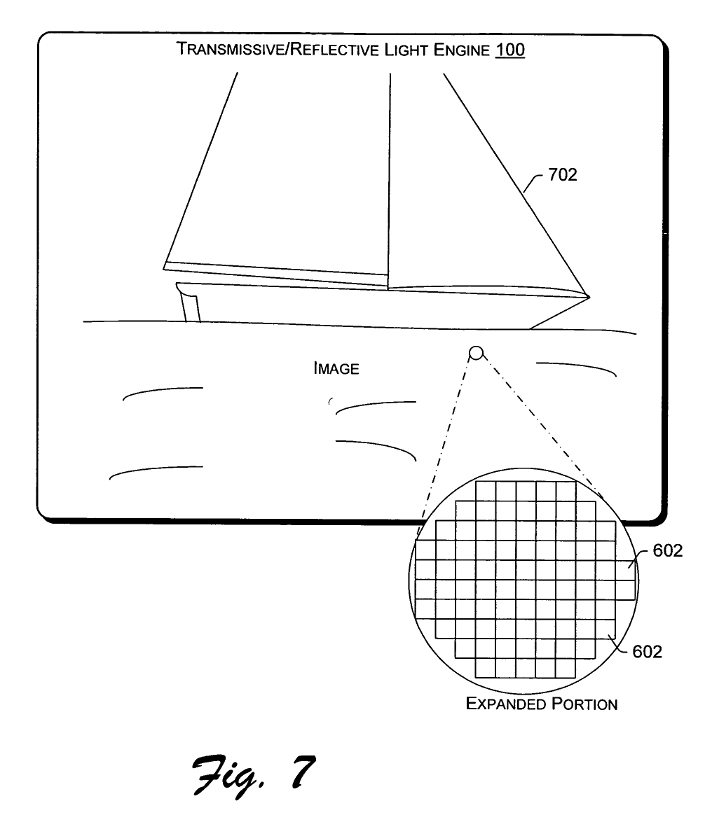

This disclosure provides different embodiments of a transmissive/reflective light engine 100 that can be configured either as a projector as described with respect to FIG. 2, or a projection display as described with respect to FIG. 6. The transmissive/reflective light engine 100 is formed from an array of light modulators 102. Each light modulator projects certain wavelengths of light at any given time, wherein the wavelength from each light modulator changes as the image changes. The transmissive/reflective light engine 100 provides a mechanism that uses both the light that is transmitted through each light modulator 102, and the light that is reflected from each light modulator to provide illumination through another light modulator to form an image that is projected or displayed to a user over the transmissive/reflective light engine.

In conventional transmissive light engines, only the light that is transmitted through each light modulator is used to provide the light to create the image. In conventional reflective light engines, only the light that is reflected from each light modulator is used to provide the light to create the image. In conventional light engines, any light that is not directed towards the user represents wasted energy. This rejection of a considerable percentage of the light by conventional light engines represents a waste of energy associated with the light. A more powerful light source is often applied to conventional light engines to compensate for the amount of this rejected and discarded light.

In this disclosure, light engines receive a certain amount of light from a light source, and direct different wavelengths of light to particular light modulators 102 that may be configured as pixels or subpixels such as are known with displays and projectors. The light from each light modulator 102 in the light engine is transmitted to a user in the form of a projected image on a projection screen; or directly from each light modulator 102 to the user in the form of a display.

This disclosure describes different embodiments of the transmissive/reflective light engine 100 that can efficiently project or display light to form an image to a user. The efficiency of a transmissive/reflective light engine 100 is considered the output light of a desired wavelength (e.g., color) from the transmissive/reflective light engine divided by all of the light that is applied to that transmissive/reflective light engine from a light source. Certain embodiments of the transmissive/reflective light engine as described in this disclosure transmits light through at least one light modulator towards a user and direct reflected light to another pixel for reuse.

One embodiment of the light modulators 102 such as included in the transmissive/reflective light engine 100 can be configured as a Fabry-Perot modulator, such as are known in the optical filters. The light modulator 102 includes two reflectors with a controllably variable space there between that define a modulator cavity. These devices allow selection of the wavelengths or colors of light that are transmitted or reflected by each light modulator. In one embodiment, the light source provides a broad band of light radiation such as wavelengths between 100 and 2000 nm.

The projecting light source 101 has to generate all the desired bands of light that can be displayed or projected by the light modulator at any time during normal operation. A given number of the transmissive/reflective (T/R) light modulators 102 can display one color of light at any given time. In one embodiment, each light modulator 102 can independently imagwise switch between red, green, or blue primary colors over time depending upon the image at that time.

Those wavelengths of light that are not transmitted are reflected, and are effectively recycled to be used by other light modulators 102 within the transmissive/reflective light engine 100. Conventional light engines include transmissive light engines or reflective light engines that are formed from an array of light modulators. Transmissive light modulators utilize the transmitted light for imaging, and reflect light that is not used for imaging; while reflective light modulators utilize the reflected light for imaging, and transmit light that is not used for imaging.

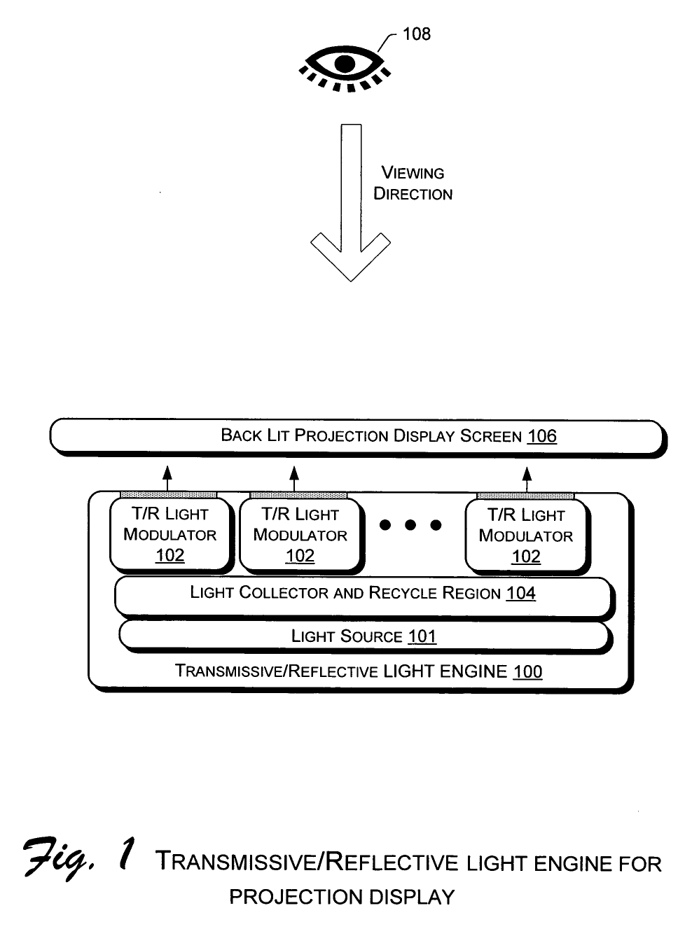

This disclosure describes a number of techniques to reuse/recycle the light reflected from the light modulators. FIGS. 1 and 2 shows block diagrams of a transmissive/reflective light engine 100 that can be configured to be used as a respective display device wherein the light engine illuminates the a display screen, or projection device wherein the light engine illuminates the projection screen. The FIGS. 1 and 2 embodiments of the transmissive/reflective light engine 100 of the present disclosure includes a light source 101, a plurality of light modulators 102, and a light collector and recycle region 104 that can in one embodiment be configured as an optical diffuser.

Each light modulator 102 of the transmissive/reflective light engine 100 is adjusted for a prescribed wavelength of light to transmit that wavelength of light through a light modulator 102 to screen (if the frequency of the light corresponds to a selected wavelength that the light modulator is transmitting at that time). Additionally, the light modulator reflects light that is not of that wavelength from the light modulator 102 into a light collector and recycle region 104 if the frequency of the light does not correspond to the selected wavelength which the light modulator is transmitting at that time.

The efficiency of the transmissive/reflective light engine 100 can be considered as that percentage of light from the light source 101 that is transmitted through the light modulators in the transmissive/reflective light engine 100 into the viewing area divided by the total light that is applied by the light source to the transmissive/reflective light engine 100. The transmissive/reflective light engines as disclosed herein can provide an efficiency of up to ninety percent, or even higher. Less energy is used to produce a particular image in more efficient displays or projectors, thereby allowing a less powerful light source to be used.

One embodiment of the light collector and recycle region 104 as described in this disclosure “recycles” light that has been reflected by one light modulator by directing the reflected light to another light modulator 102. A particular wavelength of light can continue traveling within the light collector and recycle region 104 by reflecting off a series of light modulators 102 and within the light collector and recycle region until the reflected light encounters a light modulator that transmits that particular wavelength of light. In reality this is instantaneous due to speed of light.

At any given instant, each light modulator 102 operates by transmitting light having a selected color or wavelength to the screen, while reflecting/recycling other colors/wavelengths of light. The combination of the light colors/wavelengths that are transmitted through all of the light modulators 102 within the transmissive/reflective light engine 100 at any given time form an image at the screen at that time.

Certain aspects of this disclosure relate to the increased efficiency of the transmissive/reflective light engine 100 as evidenced by certain ones of the following, and other, points labeled a) to e):

a) The transmissive/reflective light engine 100 provides up to, and perhaps greater than, a 90% light use efficiency. This light use efficiency presumes that the light modulators 102 within the transmissive/reflective light engine 100 are delievering a substantially equal amount of each the primary wavelengths of light. Even if a 90% light use efficiency is not reached, the efficiency will exceed those embodiments of conventional light engines in which the transmitted or reflected light off any light modulator is not used for display purposes.

b) The increased efficiency of the transmissive/reflective light engine 100 allows for the use of a less powerful and less expensive light source 101 that can operate with a lower operating cost. The increased efficiency also reduces the heat that is associated with the not-used light that has to be heat sinked. Lower power light sources having lower light source energy dissipation allows simpler heat management designs and operation.

c) The transmissive/reflective light engine 100 allows for precise color filtering capability, and accurate control of light modulator switching.

d) The reflectors of the transmissive/reflective light engine 100 that can approach or exceed a 90% light use efficiency displays a near perfect black in “all off” state. This results since a less powerful light source is used than with conventional light engines, and as such, each light modulators 102 can more efficiently filter out a less applied light. The transmissive/reflective light engine 100 provides a very high contrast between black portions of the transmissive/reflective light engine 100 that are projecting little or no light, and those regions of the screen that are projecting some color light.

e) Certain embodiments of the transmissive/reflective light engine 100 provide for no stiction of reflectors as occurs with certain flexures, or risk of snap down in case of certain flexures. Stiction results with capacitively driven MEMs devices when the surface attractive forces overpower the restoring force for the flexure, for small distances.

The disclosed embodiments of the transmissive/reflective light engine 100 are highly efficient since light that has been reflected or rejected in one light modulator 102 is transmitted through the light collector and recycle region 104 to be displayed in another light modulator 102. In this manner, light can continue traveling within the light collector and recycle region 104 until it encounters a light modulator 102 that is configured at that time to allow light of the wavelength to pass. Due to incredible speed of light, this is instantaneous, allowing use of most of the light at that instant.

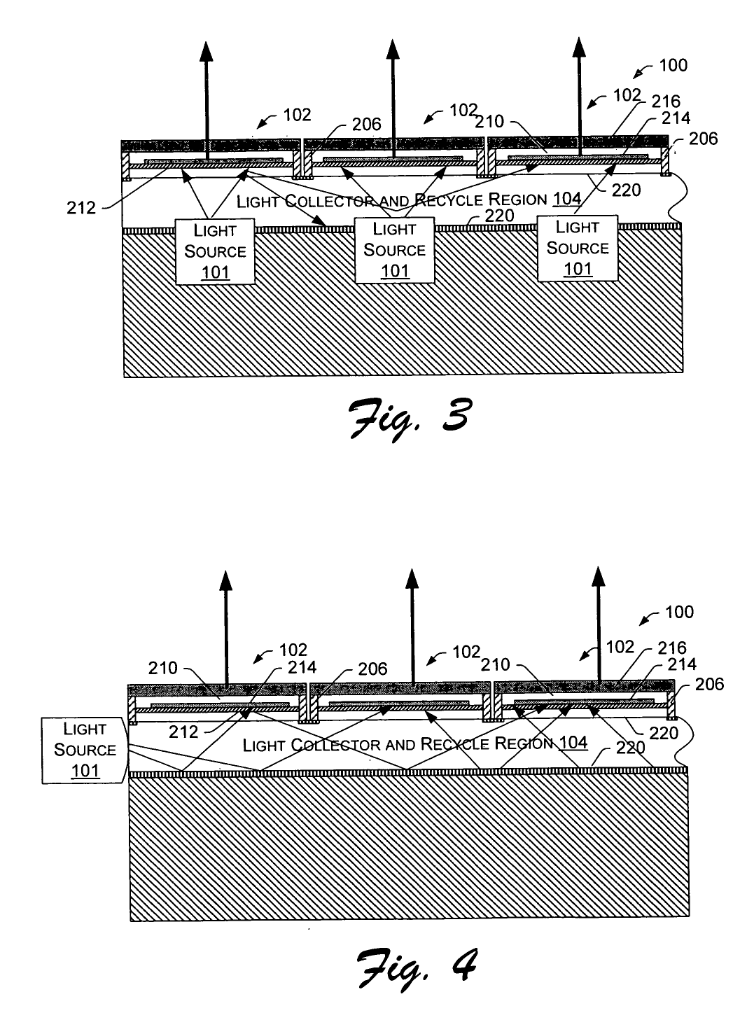

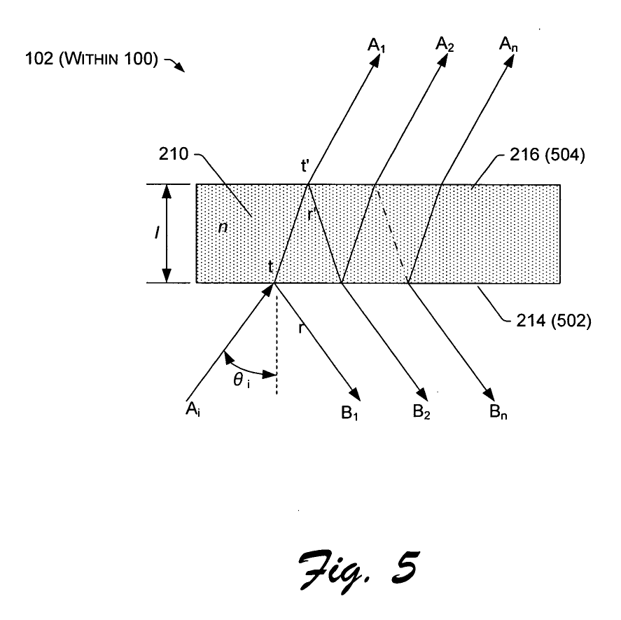

Two embodiments of the structural components of the transmissive/reflective light engine 100 that are configured to operate either as optical projectors or as optical displays are shown in cross-section in FIGS. 3 and 4. With optical projectors as shown in FIGS. 2, light is directed at a projection screen 106 that is viewed by the user 108. In FIG. 1, the projection screen 106 is back lit, while in FIG. 2 the projection screen 106 is front lit. FIG. 6 shows one embodiment of the transmissive/reflective light engine 100 being used as an optical display in which the viewers 108 view the light from the light modulator 602 directly without any intermediate projection screen.

The structure and operation of the transmissive/reflective light engine 100 of the optical display as described with respect to FIG. 6 can be similar to the structure and operation of the transmissive/reflective light engine 100 of the projector as described with respect to FIGS. 1 and 2. Alternatively, the structure or operation of the transmissive/reflective light engine 100 can be different based on whether the light from the light modulator 102 is being viewed directly or through a projection screen.

FIG. 3 shows a partial cross-sectional view of one embodiment of the transmissive/reflective light engine 100 that is formed including many light modulators 102. The transmissive/reflective light engine 100 includes at least one light source 101 that supplies light of those light wavelengths that can be transmitted by the light modulators 102; a plurality of the light modulators 102 that can transmit light with a prescribed wavelength based on interference and reflect other wavelengths of light; a spacing spring mechanism 206 and a flexure 212 for each light modulator 102 that together controls the selection of light band that is transmitted through the light modulator; and a light collector and recycle region 104 that collects the certain reflected wavelengths of the light. The light collector and recycle region 104 redirects at least some of the reflected light towards another light modulator 102. In FIG. 3, the light source 101 is configured as a light emitting diode (LED), a white light bulb, or any other suitable light source that provides all desired wavelengths of light to the light modulators 102.

Each light modulator 102 in the transmissive/reflective light engine 100 can be configured as a transmissive/reflective Fabry-Perot optical filter that includes a first planar reflective surface 214, a second planar reflective surface 216, and a spacing spring mechanism 206 and a flexure 212 that controls the spacing between the first planar reflective surface 214 and the second planar reflective surface 216. The spacing spring mechanism 206 and the flexure 212 can each be formed from a suitably flexible material such as a polymer or metal that can in different embodiments exhibit a nearly linear or a non-linear spring constants/deformation. Different configurations of spring mechanisms and flexures are commercially available.

The spacing spring mechanism 206 and the flexure 212 act either together or separately to provide for displacement of the first planar reflective surface 214 with respect to the second planar reflective surface 216, or vice versa, under an applied biasing force such as a voltage applied between the planar reflective surfaces 214, 216. In one embodiment, the spacing spring mechanism 206 acts as a compressive spring that has a prescribed spring constant, and the flexure 212 is provided with lateral bending characteristics and joints that also has a spring constant.

In many embodiments of the light modulator 102, the first planar reflective surface 214 can be moved with respect to the second reflective surface 216. In certain embodiments, this biasing force between the planar reflective surfaces 214 and 216 is provided by electrically biasing the first planar reflective surface 214 and the second planar reflective surface 216.

In one embodiment of the transmissive/reflective light engine 100 as shown in FIG. 3, the light source 101 includes at least one light emitting diode (LED) that is located near the lower surface of the light collector and recycle region 104. There may be a plurality of light sources 101 that can emit light of the desired wavelength(s) for the light modulator 102. In one embodiment, the location of each light source corresponds approximately to the location of a respective light modulator 102.

A large variety of light sources 101 can be used in combination with the transmissive/reflective light engine 100. Those light sources 101 that are described in this disclosure are intended to be illustrative in nature, and not limiting in scope. In FIG. 4, the transmissive/reflective light engine 100 includes the light collector and recycle region 104 that is connected to one or more “back lit” light source 101. The light source directs light into the light collector and recycle region 104 in such a manner that the light can be applied to the different light modulators 102. In one embodiment, the two planar reflective surfaces 214 and 216 of each light modulator 102 each have a reflectivity of between 20% and 99%. Coatings such as germanium oxide, similar to as used in fiber optic cables, are applied to the two planar reflective surfaces 214 and 216 to trap and channel light using such an optical interference device as a Fabry-Perot etalon. In one embodiment, the light collector and recycle region 104 light guide can be made of quartz, glass and germanium oxide layers or other chalcogenide materials by well established manufacture processes. This light collector and recycle region 104 redirects the unused light for reuse.

To further describe the operation and structure of the transmissive/reflective light engine 100, in one embodiment, the first planar reflective surface 214 and the second planar reflective surface 216 are both partially reflective to light applied from both sides to both planar reflective surfaces 214 and 216. The planar reflective surfaces 214 and 216 act to provide an optical interference device such as a Fabry-Perot spatial light modulator, that operates based on interference by which the spacing between the planar reflective surfaces 214 and 216 determine which wavelengths of light pass with constructive interference, and which wavelengths of light destructively interfere and/or are reflected.

In a Fabry-Perot modulator, a beam of light undergoes multiple transmission and reflection between the planar reflective surfaces 214 and 216, and a certain percentage of the resulting light is optically transmitted compared with another percentage of light that is optically reflected, based on the wavelength of the light. The dimensions which are considered as vertical height as shown in FIGS. 3 and 4, of the optical cavity 210 defined between the planar reflective surfaces 214 and 216 as shown in FIGS. 3 and 4 are of a desired dimension to provide for optical interference whereupon one or more selected wavelengths of light pass from the light collector and recycle region 104 to the viewing area 108. The spacing distance between the planar reflective surfaces 214 and 216 forming each optical cavity 210 can be adjusted to alter the wavelengths of light that can traverse the light modulator 102.

The light collector and recycle region 104 are provided with a number of recycling reflectors 220 that are configured to maintain light that is contained within the light collector and recycle region therein, are thereby is configured to allow a larger percentage of the light to be reflected off the walls to be collected and maintained therein until each wavelength of light passes out one or more suitable light modulators 102. By such collection and maintaining of the light within the light collector and recycle region 104, it is envisioned that the light will encounter a relatively large number of light modulators 102. Only those wavelengths of light that encounters a light modulator 102 that is configured to transmit those wavelengths of light will transmit that light to the users. As such, the light collector and recycle region 104 allows for the different wavelength or spectra of light to be transmitted through suitable light modulator(s) while very little light is actually discarded.

Those light guides, lenses, and mirrors that form one or more of the light modulators 102 and/or the light collector and recycle region 104 can be formed by many materials and techniques commonly known in optics. Commercial suppliers and processes are available for low cost production. Chemical vapor deposition is capable of making high optical quality silica deposits using a process in which high-purity gas mixtures are injected into a high-purity silica tube mounted in a glass-working lathe. The core glass is formed using a series of successive depositions of silica layers, doped with germanium oxide which is formed by oxidation of silicon and germanium tetrachlorides. One embodiment of this reaction that produces the core glass is controlled by the concentration and pressure of each chemical. High index glass improves the reflective effectiveness of the total internal reflective mirrors. Chalcogenides, for example, can be used to form the sides of the waveguides. Such disclosed light collector and recycle regions that are configured as optical waveguides having total internal reflective provide solid characteristics for backlit or other projection display mechanisms.

The optical cavity 210 relies on optical interference to select a wavelength of the light to transmit through the planar reflective surfaces 214 and 216 of the light modulator 102. Depending upon the selected dimension between the planar reflective surfaces 214 and 216, the flexure 212 and the thickness of the cavity to vary by allowing the first planar reflective surface 214 to be displaced.

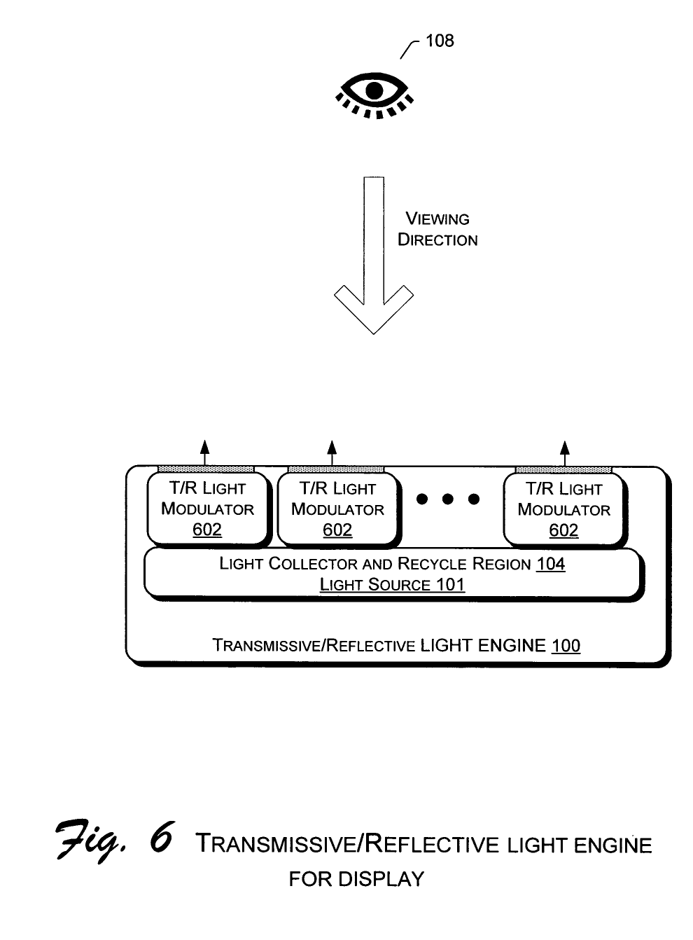

FIG. 5 shows one embodiment of an interference pattern of light that encounters the optical cavity 210 that is formed between the first planar reflective surface 214 and the second planar reflective surface 216 as shown in FIGS. 3 and 4. The interference pattern is formed as input incident light Aᵢ is applied to the optical cavity 210, from the light source 101 as shown in FIGS. 3 and 4, is reflected and/or transmitted off the planar reflective surfaces 214 and 216. The input incident light Aᵢ as shown in FIG. 5 is intended to include all wavelengths that the light modulators are likely to transmit. In one embodiment, the incident light Aᵢ is white light. Each planar reflective surface 214 and 216 is shown as being relatively thin for ease of illustration. Considering the planar reflective surfaces 214 and 216 of the transmissive/reflective light engine 100 in an ambient medium of air, light enters the light modulator 102 that has a gap with a separation distance I as shown in FIG. 5, similar to the light entering the optical cavities from below in FIGS. 3 and 4, with incident angle θᵢ. Considering the amplitude of the input incident light, Aᵢ, the reflected amplitude from the first interface 502 that is provided by the first planar reflective surface 214 is given by B₁, while the partially transmitted amplitude from the second interface 504 that is provided by the second planar reflective surface 216 is given by A₁.

FIG. 7 shows one embodiment of how the transmissive /reflective light engine 100 that is configured as a display as shown in FIG. 6 can display an image 702 to the user 108 by controlling the color of a large number of the light modulators 602. In one embodiment as shown in FIG. 3, the light source 101 includes a white light emitting diode (LED) that emits sufficient light to illuminate the light modulators 602. In another embodiment of the transmissive/reflective light engine 100 as shown in FIG. 4, the light source 101 includes a lamp that directs light into the light collector and recycle region 104 that forms a suitable optical path design to direct light to each light modulator 602. The components of the different embodiments of the light sources and optical systems such as lenses, beam splits, etc. are not shown for clarity of essential components, and substitutions using similarly operating components are within the intended scope of the present disclosure.

The image 702 is formed in response to the wavelengths or colors of light that are allowed to be transmitted through the different light modulators 602 within the transmissive/reflective light engine 100. The image 702 can change by altering the colors in certain ones of the light modulators 602. As shown in a magnified circle in FIG. 7, the light modulators 602 can be arranged in an array configuration. In one embodiment, one light source 101 as shown in FIG. 3 is associated with each light modulator 102.

FIG. 5 shows some generalized concepts that apply to those embodiments of light modulators 602 which are configured as Fabry-Perot interference devices. The coefficients of amplitude reflective (r) and transmissive (t) denote light traveling across the first planar reflective surface 214 from air to filter gap; while the coefficients (r′) and (t′), denote light traveling from filter gap to air across the second planar reflective surface 216. The multiple transmitted output A₁, A₂, . . . , Aₙ beams differ in phase due to the different path lengths traversed by each of the beams within the optical cavity 210. There are a number of reflected light outputs B₁, B₂, . . . , Bₙ that are returned to the light collector and recycle region 104. The optical phase acquired by the light on one round trip through the filter is given by equation 1.

$$Optical phase = δ = \frac{4 π n l cos θ}{λ} \qquad ( 1 )$$

where n=the index of refractive, I=thickness of the optical cavity (e.g., a Fabry-Perot etalon), and λ=wavelength of the light. The amplitudes of each of the transmitted waves can thus written as shown in equation 2:
A₁=tt′Aᵢ, A₂=tt′r′²e^{iδ}Aᵢ, A₃=tt′r^{′4}e^{2iδ}Aᵢ (2)

The sum of transmitted wave amplitudes, Aₜ, is as shown in equation 3.

$${A}_{t} = {A}_{i} t {t}^{′} ( 1 + {r}^{′ 2} {ⅇ}^{ⅈ δ} + {r}^{′ 4} {ⅇ}^{2 ⅈ δ} + … ) = \frac{t {t}^{′}}{1 - r {r}^{′} {ⅇ}^{ⅈ δ}} {A}_{i} \qquad ( 3 )$$

The fractional output intensity, or power transmissive, T=Iₜ/Iᵢ, is given by equation 4.

$$T = \frac{{I}_{t}}{{I}_{i}} = \frac{{A}_{t} {A}_{t}^{*}}{{A}_{i} {A}_{i}^{*}} = \frac{{( t {t}^{′} )}^{2}}{{( 1 - r {r}^{′} )}^{2} + 4 \sqrt{r {r}^{′}} {sin}^{2} ( δ / 2 )} \qquad ( 4 )$$

By similar derivation, equation 5 is obtained.

$$R = \frac{{I}_{r}}{{I}_{i}} = \frac{{A}_{r} {A}_{r}^{*}}{{A}_{i} {A}_{i}^{*}} = \frac{4 R {sin}^{2} ( δ / 2 )}{{( 1 - r {r}^{′} )}^{2} + 4 \sqrt{r {r}^{′}} {sin}^{2} ( δ / 2 )} \qquad ( 5 )$$

In a lossless system (T+R=1), and with r=r′ for identical filter surfaces (air gap), this equation simplifies to equations 6 and 7.

$$\begin{matrix}T = \frac{{I}_{t}}{{I}_{i}} = \frac{{A}_{t} {A}_{t}^{*}}{{A}_{i} {A}_{i}^{*}} = \frac{1}{1 + F {sin}^{2} ( δ / 2 )} & ( 6 ) \\ R = \frac{{I}_{r}}{{I}_{i}} = \frac{{A}_{r} {A}_{r}^{*}}{{A}_{i} {A}_{i}^{*}} = \frac{F {sin}^{2} ( δ / 2 )}{1 + F {sin}^{2} ( δ / 2 )} & ( 7 )\end{matrix}$$

where F=4R/(1−R)². This shows that the reflected and transmitted lights are complementary using the optical cavity 210. In other words, the optical cavity 210 of the light modulators 102 within the transmissive/reflective light engine 100 transmits selected colors while reflecting the unselected colors, or vise versa. Therefore, two independently reflective planar surfaces 214, 216 even when they are highly reflective (say 90%), when brought together at a specified distance to form the optical cavity 210 actually transmits selected wavelengths of light and reflect the rest of the frequency spectra based on interference. The optical cavity 210 could have a spacing that is less than lambda (λ) or greater than λ. This interference within the optical cavity 210 results from the classic Fabry-Perot interference effect.

Different embodiments of the spacing actuator device 206 that relatively displaces the planar reflective surfaces 214, 216 with respect to each other. The spacing actuator device 206 includes a piezoelectric device such as a “piezo bender”, or an electrostatic actuator, or any other mechanism that can precisely control the spacing between the first planar reflective surface and the second planar reflective surface. The spacing actuator device 206 moves the first planar reflective surface 214 with respect to the second planar reflective surface 216 in response to control voltage, thereby changing the gap of the Fabry-Perot optical cavity 210 and tuning the light modulator 102. The light modulator 102 transmits the specified color band corresponding to a ½ wavelengths spacing between the planar reflective surfaces 214, 216, and reflects the unused color (light).

The unused colors are redirected to light guide source cavity, and/or collected on a reflector location within the light collector and recycle region 104, and is applied to the same or another light modulator 102 so that the light can be recycled. Therefore, this device offers significant increase in the brightness and contrast of the display device when using a particular light source 101 (see FIGS. 3 and 4). In other words, the transmissive/reflective light engine 100 may be considered as a high efficiency Fabry-Perot light modulator that includes at least one transmissive/reflective light modulator 102 and the light collection and recycle region 104. The light modulators 102 of the transmissive/reflective light engine 100 uses transmitted light for visualization of image and the reflected light is recycled.

In another embodiment, the second planar reflective surface 216 is actuated to be displaced with respect to the first planar reflective surface 214 using, for example, a piezo bender actuator. The piezo bender or electrostatic actuator consists of multilayer thin film; or a thin piezoelectric layer is sandwiched between two electrodes. When a voltage is applied through the electrodes, the dimensional change of Piezo actuator, or electrostatic force, causes the gap dimension between the planar reflective surfaces 214, 216 to change in a desired manner. In an even more complex design, both planar reflective surfaces 214 and 216 can be moved with respect to each other. Moving at least one of the planar reflective surfaces 214, 216 changes the gap dimension, and hence the interference pattern of the light. By changing the interference pattern of the light, the bandwidths of light that can be transmitted compared to those wavelengths of light that are reflected through each light modulator 102 can be controlled.

Using the Fabry-Perot optical cavity 210 in a mode where transmissive is cause for visualization, allows the “unused” bands to reflect in the light guide and be reused. The light collector and recycle region 104 is formed using well established conventional photolithographic or printing/embossing and deposition processes. The light modulator of this invention can be used for projection and backlit display application for rendering high color and high contrast images.

In summary, the transmissive/reflective light engine 100 can be constructed and operated in manners similar to conventional Fabry-Perot optical devices. Arrays of light modulators 102 can be used to form transmissive/reflective light engine 100 that act as a transmissive/reflective wavelength selector for a given Fabry-Perot cavity in the array element. In one embodiment the light modulators 102 is combined with the light collector and recycle region 104 that is configures as a light guide that allows collection and recycle of unused band of light, while the transmitted light is used for rendering color image. The gap between two planar reflective surfaces 214 and 216 is changed for selecting the band of color to be transmitted and the rest to be reflected to source or light guide. Although electrostatic force can be used to regulate the gap between the two planar reflective surfaces 214 and 216, another solution involves using piezo actuators to control the relative positioning of the two planar reflective surfaces 214 and 216.

This disclosure thereby can relatively efficiently provide good illumination to large images to projectors and displays. Having herein set forth preferred embodiments of the present invention, it is anticipated that suitable modifications can be made thereto which will nonetheless remain within the scope of the present invention.

1. A transmissive/reflective light engine, comprising:
a plurality of light modulators, at least one light modulator transmitting certain wavelengths of the light to be projected towards a user, and reflecting other wavelengths of the light; and
a light collector and reflector assembly that collects the reflected certain wavelengths of the light, and redirects at least some of the light reflected from the light modulator towards another one of the plurality of light modulators to be projected towards the user.

2. The transmissive/reflective light engine of claim 1, further comprising a light source that generates the light.

3. The transmissive/reflective light engine of claim 1, wherein the at least some of the reflected light is able to be transmitted through another one of the plurality of light modulators.

4. The transmissive/reflective light engine of claim 1, in which at least one of the plurality of light modulators includes an assembly of layers, the assembly of layers provide for dynamic choice of wavelength or band of wavelength to be transmitted, and allows for the reflection of the light for reuse.

5. The transmissive/reflective light engine of claim 1, in which the source of light provides for a bandwidth of light between 100 nm and 2000nm.

6. The transmissive/reflective light engine of claim 1, in which the light modulators are configured as optical filters that include a first reflective surface, a second reflective surface, and a spacing actuator device that controls spacing between the first reflective surface and the second reflective surface.

7. The transmissive/reflective light engine of claim 6, wherein the spacing actuator device includes a piezoelectric device.

8. The transmissive/reflective light engine of claim 6, wherein the spacing actuator device includes a flexure mechanism.

9. The transmissive/reflective light engine of claim 1 that is used as a projector.

10. The transmissive/reflective light engine of claim 9, wherein the projector illuminates a projection screen.

11. The transmissive/reflective light engine of claim 1 that is used as a display.

12. The transmissive/reflective light engine of claim 11, wherein the projector illuminates a display screen.

13. The transmissive/reflective light engine of claim 1, further comprising a light source that generates the source light and applies the source light into a collector and recycle region of the transmissive/reflective light engine.

14. The transmissive/reflective light engine of claim 1, further comprising a light guide that is optically positioned between a transmissive/reflective layer and the light collector and reflector assembly.

15. The transmissive/reflective light engine of claim 1, further comprising a light conducting device that is optically positioned between a transmissive/reflective layer and the light collector and reflector assembly.

16. The transmissive/reflective light engine of claim 1, in which the light collector and reflector assembly includes a recycling reflector.

17. The transmissive/reflective light engine of claim 1 that acts as a spatial light modulator.

18. The transmissive/reflective light engine of claim 1, in which the source light includes white light.

19. A method, comprising:
increasing the percentage of light that is transmitted through a plurality of light modulators within a transmissive/reflective light engine, wherein the transmitted light is directed through the light modulator is projected towards a user, and some of reflected light that is reflected off the light modulator is directed to be transmitted trough another light modulator towards the user.

20. The method of claim 19, further comprising projecting the light that is transmitted through at least one of the light modulator towards a side of a projection screen that the viewer views.

21. The method of claim 19, further comprising projecting the light that is transmitted through at least one of the light modulator towards a side of a projection screen that is opposed to the side that the viewer views.

22. The method of claim 19, further comprising displaying the light that has transmitted through at least one of the light modulators directly to a user.

23. An apparatus, comprising:
modulating means for transmitting light through at least two light modulators, wherein the modulating means is configured to reflect light which is not to be projected off of the light modulator, and
recycling means for the increasing a percentage of light that is transmitted through the modulating means, wherein said recycling means comprises a mechanism for receiving some of the reflected light and applying it to at least one other light modulator.

24. The apparatus of claim 23, wherein the modulating means includes a light collector and recycle region.
